(19) United States
(12) Patent Application Publication
(10) Pub. No.: US 2009/0107556 A1
(43) Pub. Date: Apr. 30, 2009

(54) Fluid Dispensing Fake Body Part and Method for Making the Same

(76) Inventor: Edward Marshall, Castalia, OH (US)

Correspondence Address: ERIC HANSCOM, 7395 PORTAGE WAY, CARLSBAD, CA, 92011, US

(21) Appl. No.: 11/932,396

(22) Filed: Oct. 31, 2007

(51) Int. Cl. F17D 1/16; A41F 17/02; F16K 21/00

(52) U.S. Cl. 137/14; 137/801; 24/72.1

(57) ABSTRACT

An apparatus that resembles a part of the human body that can dispense fluids is disclosed. The body part is made out of a polymer, where the shape of the body part is determined by a mold. Tubing is used to transport the liquid. One end of the tubing is flush with the edge of the body part such that the tube does not protrude from the body part but also can dispense fluid freely. A nozzle can be included in this end to direct the flow of the fluid. The other end of the tubing is connected to a container with a pump, where the pump can dispense continuous or specific amounts of fluid. Alternatively, gravity can be used to force the fluid through the nozzle. The apparatus can be designed for use by an individual or separate from an individual.

### CROSS REFERENCE TO RELATED APPLICATIONS

None.

### STATEMENT REGARDING FEDERALLY SPONSORED RESEARCH OR DEVELOPMENT

This invention was not federally sponsored.

### BACKGROUND OF THE INVENTION

### Field of the Invention

This invention relates to the general field of fluid dispensing devices, and more specifically toward an apparatus that resembles a part of the human body that can dispense fluids. The body part is made out of a polymer, where the shape of the body part is determined by a mold. Tubing is used to transport the liquid. One end of the tubing is flush with the edge of the body part such that the tube does not protrude from the body part but also can dispense fluid freely. A nozzle can be included in this end to direct the flow of the fluid. The other end of the tubing is connected to a container with a pump, where the pump can dispense continuous or specific amounts of fluid. Alternatively, gravity can be used to force the fluid through the nozzle. The apparatus can be designed for use by an individual or separate from an individual.

Special effects have been used in a variety of fields to create an event that would not normally be possible. Television, film, and even theatrical productions, use devices or methods, which are often expensive, to create effects that the viewer would normally think impossible. Theatrical productions, and even television shows or films that require multiple takes, also require that their special effects be reusable, or in the alternative, inexpensive, such that the same special effect can be repeated multiple times. Practical jokes, or pranks, use similar methodology to trick unknowing individuals. Practical jokes and special effects require that the unknowing party view nothing out of the ordinary until the practical joke or special effect is performed.

Mimicking different parts of the human body has been performed for hundreds of years. Fake hands have been cut off of actors where a substance resembling blood discharges from the fake wound. When this occurs, the substance is stored near the discharge area, or fed through a tube that is hidden in the actor's clothes. Fake drowning victims spit water out of their mouths, but the amount of water discharged is no more than the amount they can store in their mouth. As a practical joke, clowns have asked unknowing individuals to smell the flower on the clown's shirt. When the individual gets close, the clown squirts water into the person's face. This “squirting flower” practical joke, however, requires that the clown direct the unknown individual towards a part of his body that is clothed, such that the appropriate tubing and fluid storage compartments can be hidden. Many individuals are aware of the squirting flower practical joke and would not be fooled again.

Thus there has existed a long-felt need for an apparatus that is capable of creating a special effect or performing a practical joke. This device should discharge a fluid on demand by the user, either in predetermined amounts or continuously. It should resemble a body part such that an individual viewing the device could mistake it for an actual body part. Tubing or other elements used to discharge the fluid should not be noticeable to the viewing individual.

The current invention provides just such a solution by having an apparatus that resembles a part of the human body that can dispense fluids. The body part is made out of a polymer, where the shape of the body part is determined by a mold. Tubing is used to transport the liquid. One end of the tubing is flush with the edge of the body part such that the tube does not protrude from the body part but also can dispense fluid freely. A nozzle can be included in this end to direct the flow of the fluid. The other end of the tubing is connected to a container with a pump, where the pump can dispense continuous or specific amounts of fluid. Alternatively, gravity can be used to force the fluid through the nozzle. The apparatus can be designed for use by an individual or separate from an individual.

There has thus been outlined, rather broadly, the more important features of the invention in order that the detailed description thereof may be better understood, and in order that the present contribution to the art may be better appreciated. There are additional features of the invention that will be described hereinafter and which will form the subject matter of the claims appended hereto. The features listed herein and other features, aspects and advantages of the present invention will become better understood with reference to the following description and appended claims. The accompanying drawings, which are incorporated in and constitute part of this specification, illustrate embodiments of the invention and, together with the description, serve to explain the principles of the invention.

### SUMMARY OF THE INVENTION

The current invention is simple and relatively inexpensive to manufacture. Various different methods of manufacturer are available depending on the polymer used to create the skin of the fake body part. One simple process for create the apparatus uses latex as the polymer. A mold is created with the negative imprint of the body part that is to be manufactured. It is preferable to create the mold with an area larger than the specific body part that is to be manufactured. This allows the finished product to completely surround the user and hide any tubing or other elements that are a part of the apparatus. Plastic tubing is inserted into the mold such that one end of the tubing is flush with the mold. Latex is then poured into the mold, where the latex will become the skin of the fake body part. While latex is preferably used to create the skin of the fake body party, the inventor contemplates that different polymers can be used to create the skin of the fake body part, such as acrylonitrile butadiene styrene (ABS) plastic, silicone, or polyurethane. The latex is then allowed to set, preferably for a period of 20-30 minutes. The length of time that the latex is allowed to set determines the thickness of the latex; the longer the latex is allowed to set the thicker the finished product becomes. After the latex has set, the remaining liquid latex is removed by pouring it out of the mold. The mold is then filled with expandable foam latex. The foam should be evenly distributed and allowed to set for at least 10 minutes, and preferably 15 to 20 minutes.

The fake body part is now removed from the mold. Any straps, cloth, or other means to secure the fake body part to a user or to use it separately are attached. The latex is also cleaned and then, optionally, painted to render a more life-like appearance of the fake body part. The painting can include skin tones, blemishes, or other coloring that clearly depicts the specific body part. The tubing is then cut to an appropriate size, and attached to a pump. The pump is connected to a container where the fluid is stored. The pump can be an electrically powered pump, a hand powered pump, or any other means to force fluid from a container through the tubing. For a hand powered pump, the user can activate a mechanical pump, or simply squeeze a pliable container thereby forcing the fluid out of the container and through the tubing. In another alternative, the tubing is attached to a funnel and gravity is used to force the fluid through the tubing and out the nozzle.

The finished apparatus is also easy to operate. It is secured to the user, another object, or simply used alone. The container is filled with fluid. The user then simply activates the pump, which then discharges a set or continuous amount of fluid, depending on the configuration of the apparatus and the wishes of the user. It is contemplated by the inventor that the fluids could be a liquid or a gas.

One embodiment of the apparatus is a fake nose connected to manually operated pumps that dispense set amounts of liquid. The mold is designed such that the nose as well as much of the face is created. This allows for the tubes to be hidden behind the fake skin, and the tubes can exit behind the users head and travel to the pumps. The user manually activates the pumps, which causes a liquid to be dispensed from the nose. The fake nose apparatus can be used as a special effect or practical joke, where the fluid could simulate mucus, blood, or anything else the user desires.

Another embodiment of the apparatus is a fake end of an arm as if the hand had been cut off. A significant amount of the arm should be included in the apparatus, such that the tubing that leads to the end of the apparatus is hidden from view of individuals. A fake hand can be attached to the end of the apparatus. When the fake hand is removed, the user can activate the pump, and fake blood can be discharged from the apparatus, as if the hand was cut off of the limb.

An additional embodiment of the apparatus is a fake stomach of an individual that includes a belly button. The mold should be created such that the apparatus includes a significant amount of the stomach to hide the tubes that lead to the pump, which are preferably located behind the user's back. In this embodiment, the user may play a practical joke on another individual. The user may ask the individual to look at his or her stomach, specifically the belly button. When the individual comes close, the user may activate the pump, which discharges a set amount of fluid, preferably water. The water that is discharged will surprise the individual. This practical joke is similar to the “squirting flower” practical joke used by clowns, but is not as widely known and therefore more effective.

Another embodiment of the apparatus is a fake front of a person's chest or torso. The mold should be created such that the apparatus includes a significant amount of a person's chest or torso to hide the tubes that lead to the one or more pumps. One or more tubes can discharge water from various locations of the chest or torso, including, but not limited to, the nipples, over where the heart would be located, or the center of the chest or torso. Fake blood can be discharged as if wounded, milk can be discharged from the nipples as if breast feeding, or any other fluid can be discharged that the user desires. When painting the apparatus, the nipples can be painted a different color than the skin, and skin tones can be painted to help define the shape of the apparatus or mimic muscle structure. If the apparatus is to resemble a male's chest or torso, hair can be added to help the apparatus resemble the real body part as much as possible.

The invention can also include the use of gas as a fluid. An embodiment of the invention is an apparatus that includes fake ears, where the apparatus is worn on the head of the user. Two tubes are used, one connected to each ear, where the end of the tube ends at what would be the ear canal. When the user activates the pump, a gas is discharged from the tubes, where this gas is preferably colored. This can create the special effect of steam or smoke escaping from the user's head, as if the user's head is on fire.

The inventor also contemplates an embodiment of the invention where a user does not wear the apparatus. The apparatus could be a fake mouth, or even a fake head, where water is discharged from the apparatus when the pump is activated. The apparatus could function similar to a drinking fountain, where the water could exit from the fake mouth. The tubes could be connected to a pump and a container, or a valve and a fluid source, where the fluid is pressurized so that when the valve is open, fluid flows through the tubes and is discharged from the device.

It is a principal object of the invention to provide an apparatus that resembles a body part and discharges one or more fluids.

It is another object of the invention to provide an apparatus that is reusable and easy to use.

It is a final object of this invention to provide an apparatus that can aid in performing special effects or practical jokes.

It should be understood the while the preferred embodiments of the invention are described in some detail herein, the present disclosure is made by way of example only and that variations and changes thereto are possible without departing from the subject matter coming within the scope of the following claims, and a reasonable equivalency thereof, which claims I regard as my invention.

### BRIEF DESCRIPTION OF THE FIGURES

FIG. 1A is a perspective view of the fluid dispensing apparatus as a fake arm with the hand cut off. FIG. 1B is a side view of said device. FIG. 1C is a rear view of the device without the external tubing, container, and pump.

FIG. 2 is a front view of the fluid dispensing apparatus as a fake nose.

FIG. 3 is a front view of the fluid dispensing apparatus as a fake head, which is attached to a drinking fountain.

### DETAILED DESCRIPTION OF THE FIGURES

Many aspects of the invention can be better understood with reference to the drawings below. The components in the drawings are not necessarily drawn to scale. Instead, emphasis is placed upon clearly illustrating the components of the present invention. Moreover, like reference numerals designate corresponding parts through the several views in the drawings.

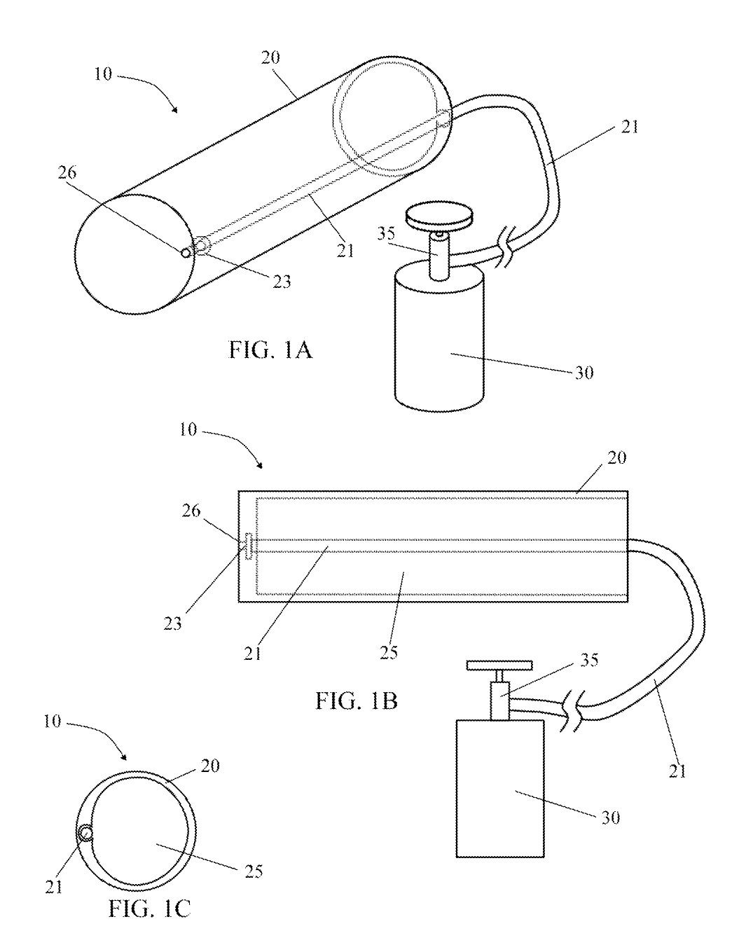

FIG. 1A is a perspective view of the fluid dispensing apparatus as a fake arm with the hand cut off. The fluid dispensing apparatus 10 includes a fake body part 20, which in this embodiment is supposed to resemble an arm with the hand cut off. At the end of the fake body part 20 there is an opening 26 where fluid can be dispensed. Inside of the fake body part 20 is tubing 21, which attaches to a nozzle 23. The nozzle 23, in turn, is connected to the opening 26 such that fluid flowing through the tubing 21 towards the nozzle 23 exits the opening 26. Traveling away from the nozzle 23, the tubing continues outside of the fake body part 20 until it reaches a pump 35. The pump 35 is also connected to a container 30, which can store fluid. The pump 35, when activated by the user, forces fluid from the container 30 through the tubing 21 to the nozzle 23, where it is dispensed through the opening 26 and away from the fluid dispensing apparatus 10.

FIG. 1B is a side view of the fluid dispensing apparatus as a fake arm with the hand cut off. The fluid dispensing apparatus 10 includes a fake body part 20, which in this embodiment is supposed to resemble an arm with the hand cut off. At the end of the fake body part 20 there is an opening 26 where fluid can be dispensed. Inside of the fake body part 20 is tubing 21, which attaches to a nozzle 23. The nozzle 23, in turn, is connected to the opening 26 such that fluid flowing through the tubing 21 towards the nozzle 23 exits the opening 26. Traveling away from the nozzle 23, the tubing continues outside of the fake body part 20 until it reaches a pump 35. The pump 35 is also connected to a container 30, which can store fluid. The pump 35, when activated by the user, forces fluid from the container 30 through the tubing 21 to the nozzle 23, where it is dispensed through the opening 26 and away from the fluid dispensing apparatus 10. In this embodiment, a user wears the device by placing his or her arm into a cavity 25 located inside of the fake body part 20.

FIG. 1C is a rear view of the fluid dispensing apparatus as a fake arm with the hand cutoff, without the external tubing, container, and pump. The fluid dispensing apparatus 10 includes a fake body part 20, which in this embodiment is supposed to resemble an arm with the hand cut off. Inside of the fake body part 20 is a cavity 25. In this embodiment, a user wears the device by placing his or her arm into the cavity 25. The fake body part also includes tubing 22 that is located inside of the fake body part 20. In the fake body part 20 there is an opening, however, to allow removal of the tubing 22. The tubing 22 is used to transport a fluid through the fake body part 20.

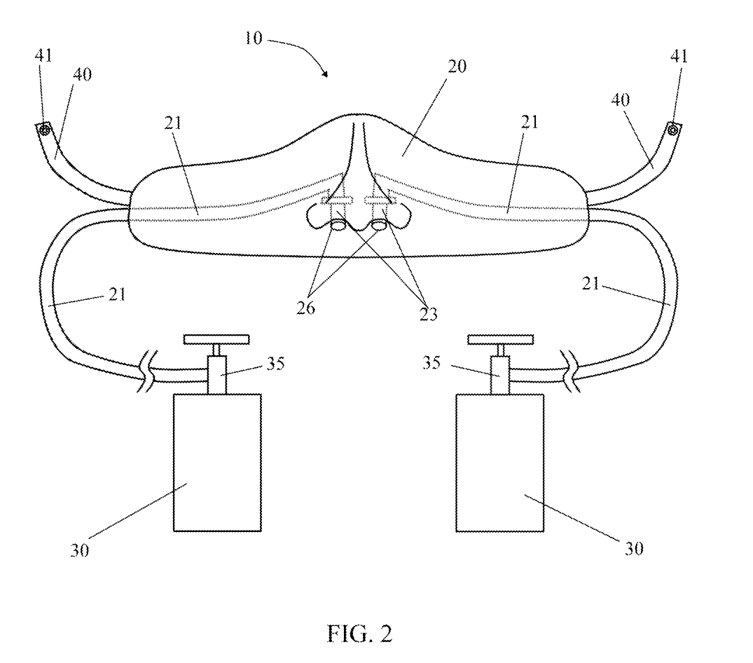

FIG. 2 is a front view of the device as a fake nose. The fluid dispensing apparatus 10 includes a fake body part 20, which in this embodiment is supposed to resemble a nose. The fake body part 20 has two openings 26 where fluid can be dispensed. Inside of the fake body part 20 is tubing 21, which attaches to a nozzle 23. The nozzle 23, in turn, is connected to the opening 26 such that fluid flowing through the tubing 21 towards the nozzle 23 exits the opening 26. Traveling away from the nozzle 23, the tubing continues outside of the fake body part 20 until it reaches a pump 35. The pump 35 is also connected to a container 30, which can store fluid. The pump 35, when activated by the user, forces fluid from the container 30 through the tubing 21 to the nozzle 23, where it is dispensed through the opening 26 and away from the fluid dispensing apparatus 10. The fluid dispensing apparatus 10 also includes straps 40. At the end of the straps 40 there are fasteners 41. The straps 40 and fasters 41 are used to secure the fluid dispensing apparatus 10 to a user.

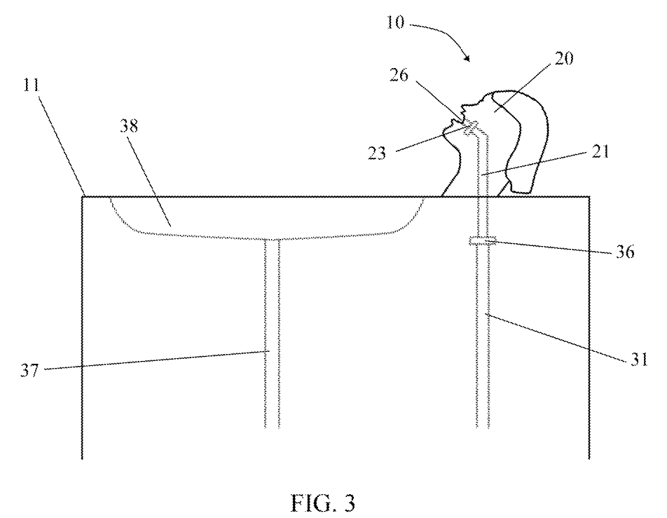

FIG. 3 is a front view of the fluid dispensing apparatus as a fake head, which is attached to a drinking fountain. The fluid dispensing apparatus 10 includes a fake body part 20, which in this embodiment is supposed to resemble a human head. At one location of the fake body part 20, where the lips of the human head would be located, there is an opening 26 where fluid can be dispensed. Inside of the fake body part 20 is tubing 21, which attaches to a nozzle 23. The nozzle 23, in turn, is connected to the opening 26 such that fluid flowing through the tubing 21 towards the nozzle 23 exits the opening 26. Traveling away from the nozzle 23, the tubing continues outside of the fake body part 20 until it reaches a valve 36. The valve 35 is also connected to a water supply line 31, where fluid, such as water, can be transported to the fluid dispensing apparatus. The valve 35, when activated by the user, allows fluid from the water supply line 31 to travel through the tubing 21 to the nozzle 23, where it is dispensed through the opening 26 and away from the fluid dispensing apparatus 10. The fluid dispensing apparatus, in this embodiment, is attached to a drinking fountain 11. The drinking fountain 11 includes a water collecting basin 38 which collects fluid dispensed from the fluid dispensing apparatus 10 and channels it to a drain 37.

What I claim is:

1. An apparatus that discharges one or more fluids comprising
a polymer skin, where the polymer skin comprises an external wall and an internal wall, where the external wall is designed to resemble the external surface of a part of the human body,
one or more sources of fluid, where the fluid can be a liquid or a gas,
one or more tubes, where one end of each tube, known as the discharge end, is located in the polymer skin such that the discharge end is flush with the external wall of the polymer skin, where the other end of each tube, known as the fluid source end, is connected to one of the one or more sources of fluid, and where fluid that flows inside of a tube towards the discharge end is discharged from the apparatus at the location where the discharge end is located,
a means for causing fluid to flow from the one or more sources of fluid through the one or more tubes towards the discharge end of the one or more tubes such that fluid is discharged from the apparatus.

2. The apparatus of claim 1, where the polymer skin comprises latex.

3. The apparatus of claim 1, where the polymer skin comprises silicone.

4. The apparatus of claim 1, where the polymer skin comprises polyurethane.

5. The apparatus of claim 1, where the polymer skin comprises ABS plastic.

6. The apparatus of claim 1, where the number of sources of fluid is less than or equal to the number of tubes.

7. The apparatus of claim 1, where the means for causing fluid to flow is gravity.

8. The apparatus of claim 7, where the one or more sources of fluid is one or more funnels.

9. The apparatus of claim 1, where the means for causing fluid to flow is a pump, where the pump is activated by a user.

10. The apparatus of claim 9, where the pump is a hand powered pump.

11. The apparatus of claim 9, where the pump is an electrically powered pump.

12. The apparatus of claim 9, where a set amount of fluid is discharged from the apparatus each time the pump is activated.

13. The apparatus of claim 9, where a continuous amount of fluid is discharged from the apparatus while the pump is activated.

14. The apparatus of claim 1, where the one or more sources of fluid is one or more containers.

15. The apparatus of claim 1, where the fluid is water.

16. The apparatus of claim 1, where the fluid is breast milk.

17. The apparatus of claim 1, where the fluid is infant formula.

18. The apparatus of claim 1, where the fluid resembles blood.

19. The apparatus of claim 1, where the fluid comprises alcohol.

20. The apparatus of claim 1, where the fluid is smoke.

21. The apparatus of claim 1, where the one or more sources of fluid is one or more water supply lines and where the fluid is water.

22. The apparatus of claim 1, where the apparatus further comprises a nozzle, where the nozzle is connected to the discharge end of the one or more tubes, where the nozzle directs and regulates the flow of the fluid discharged from the apparatus.

23. The apparatus of claim 1, where the apparatus is designed to be worn by a user.

24. The apparatus of claim 23, where the apparatus further comprises straps, where the straps are designed to secure the apparatus to the user.

25. The apparatus of claim 1, where the polymer skin has been painted.

26. The apparatus of claim 1, where the external wall of the polymer skin is designed to resemble a nose and surrounding portions of the face.

27. The apparatus of claim 1, where the external wall of the polymer skin is designed to resemble an ear and the surrounding portions of the head.

28. The apparatus of claim 1, where the external wall of the polymer skin is designed to resemble a stomach including the belly button.

29. The apparatus of claim 1, where the external wall of the polymer skin is designed to resemble the chest of a human.

30. The apparatus of claim 29, where the human is female.

31. The apparatus of claim 29, where the human is male.

32. The apparatus of claim 31, where objects that resemble hair are attached to the polymer skin.

33. The apparatus of claim 1, where the external wall of the polymer skin is designed to resemble a mouth.

34. The apparatus of claim 1, where the external wall of the polymer skin is designed to resemble a severed limb.

35. A method for making an apparatus resembling a part of the human body that discharges fluid comprising
first, creating a mold, where the mold is a negative imprint of a part of the human body,
second, inserting one or more tubes into the mold, where the one or more tubes are inserted by placing one end of each tube, known as the discharge end, proximate to the mold, and placing the other end of the each tube, known as the fluid source end, outside of the mold
third, pouring liquid latex into the mold,
fourth, allowing the liquid latex to set for a period of time,
fifth, removing the remaining unset liquid latex,
sixth, filling the mold with expandable foam latex,
seventh, allowing the expandable foam latex to set for a period of time,
eighth, removing the set object, which includes the set liquid polymer, set expandable foam latex, and one or more tubes,
ninth, cutting the one or more tubes to desired lengths,
tenth, attaching the fluid source ends of the one or more tubes to a means for causing a fluid to flow from the fluid source end to the discharge end of the one or more tubes.

36. The method of claim 35, where the period of time in the fourth step is between 20 and 30 minutes.

37. The method of claim 35, where the period of time in the seventh step is between 10 and 20 minutes.

38. The method of claim 35, where a means for securing the apparatus to a user is attached to the set object after the eighth step.

39. A method for dispensing fluid comprising the steps of
first, obtaining an apparatus that discharges one or more fluids comprising
a polymer skin, and where this polymer skin comprises an external wall and an internal wall, where the external wall is designed to resemble the external surface of a part of the human body,
one or more containers, where the containers store fluid,
one or more tubes, where one end of each tube, known as the discharge end, is located in the polymer skin such that the discharge end is flush with the external wall of the polymer skin, where the other end of each tube, known as the fluid source end, is connected to one of the one or more sources of fluid, and where fluid that flows inside of a tube towards the discharge end is discharged from the apparatus at the location where the discharge end is located,
a pump which is used to cause fluid to flow from the one or more sources of fluid through the one or more tubes towards the discharge end of the one or more tubes such that fluid is discharged from the apparatus, where the pump can be activated by a user, where the pump, when activated, dispenses a set amount of fluid,
where the apparatus is designed to be worn by a user, where the apparatus further comprises straps to secure the apparatus to the user,
second, securing the apparatus to the user,
third, filling the one or more containers with a liquid,
fourth, activating the pump thereby causing the apparatus to discharge a set amount of liquid.
